(19) United States
(12) Patent Application Publication
(10) Pub. No.: US 2024/0354526 A1
(43) Pub. Date: Oct. 24, 2024

(54) READER

(71) Applicant: ASTERISK, INC., Osaka-shi, Osaka (JP)

(72) Inventor: Noriyuki SUZUKI, Osaka-shi (JP)

(21) Appl. No.: 18/682,423

(22) PCT Filed: Aug. 11, 2022
(86) PCT No.: PCT/JP2022/030699

§ 371 Date: Feb. 8, 2024

(30) Foreign Application Priority Data
Aug. 12, 2021 (JP) 2021-131834

(51) Int. Cl. G06K 7/10; H01Q 1/10

(52) U.S. Cl. CPC G06K 7/10386; H01Q 1/10

(57) ABSTRACT

A reader includes a sensor unit having a sensor to read information from a machine-readable medium, a mobile information terminal to acquire information from the sensor unit, and an extendable rod to extend and contract, and hold the sensor unit and the mobile information terminal. The extendable rod includes a unit holder configured to hold the sensor unit, and a terminal holder at a handle that the extendable rod has and is to be grasped by a user, the terminal holder holding the mobile information terminal, and the extendable rod being extendable so as to shorten and lengthen a distance between the sensor holder and the handle.

### CROSS-REFERENCE TO RELATED APPLICATION

This application is a U.S. National Stage application of International Application No. PCT/JP2022/030699, filed Aug. 11, 2022, which claims priority to Japanese Application No. 2021-131834, filed Aug. 12, 2021, the contents of which are hereby incorporated by reference.

### TECHNICAL FIELD

The present invention relates to readers.

### BACKGROUND INFORMATION

Barcode readers have been used as readers to read information from articles. In recent years, RFID readers have been used in different operations such as logistics management, production management, and accounting processing and inventory management in stores. These readers include stationary readers that are used while stationary and portable readers that are used while being carried around, and the type of readers that are suitable for the purpose is used.

JP 4692285 B describes a portable RFID reader. This RFID reader includes a main body, a grip extending downward from the main body, and an antenna. In this RFID reader, the antenna is located inside the distal end of the main body. With this configuration, even if the RFID reader is dropped, the main body or grip will collide with the ground, so that damage to the antenna will be reduced.

### SUMMARY

Portable RFID readers including the one described in JP 4692285 B have excellent operability because the user can operate them at hand. The readable range, however, is limited to the output strength of the wireless signal (electromagnetic induction, radio wave) output from the reader. The user therefore has to move if the RF tag is located outside the reader's radio signal output range. For instance, when commodities are displayed on a relatively high display shelf that is out of reach of users in a store, and information is to be read from the RF tags attached to these commodities, the user needs to use a stand or stepladder if these commodities are located outside the output range of the RFID readers' radio signal. In this way, reading the information from RF tags located outside the output range of radio signal requires user's time and effort.

This situation occurs not only when reading information from RF tags, but also when reading information from symbols such as barcodes.

In view of the above-described problems, the present disclosure aims to provide a reader capable of expanding the readable range without impairing the operability.

To achieve the above aim, a reader of the present disclosure includes: a sensor unit having a sensor configured to read information from a machine-readable medium; a mobile information terminal configured to acquire information from the sensor unit; and an extendable rod that extends and contracts, and holds the sensor unit and the mobile information terminal. The extendable rod includes: a holder that holds the sensor unit, and a terminal holder at a handle that the extendable rod has and is grasped by a user, the terminal holder holding the mobile information terminal. The extendable rod is extendable to make a distance between the sensor holder and the handle longer and shorter.

The reader of the present disclosure expands the readable range without impairing the operability.

### BRIEF DESCRIPTION OF THE DRAWINGS

FIG. 1A is a plan view of an RFID reader according to a first embodiment of the present disclosure in an extended state, and FIG. 1B is a plan view of the RFID reader according to the first embodiment in a retracted state.

FIG. 2 is a block diagram of the RFID unit that the RFID reader includes.

FIG. 3A is a side view of the reader/writer holder of the reader, and FIG. 3B is an AA sectional view of the side view.

FIG. 4A is a side view of the terminal holder of the reader, and FIG. 4B is sectional view of the side view along BB.

### DETAILED DESCRIPTION

The following describes embodiments of the present disclosure, by way of an example of a RFID reader that reads information from a RF tag.

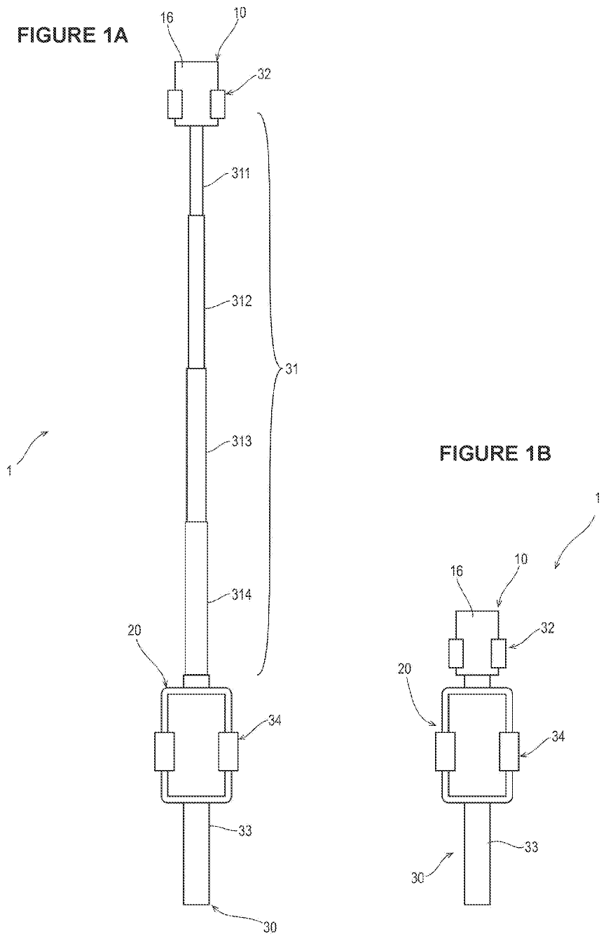

As shown in FIGS. 1A and 1B, the RFID reader 1 of this embodiment is a portable reader that reads information from RF tags attached to commodities displayed in a store, for example, and includes an RFID unit 10, a mobile information terminal 20, and an extendable rod 30.

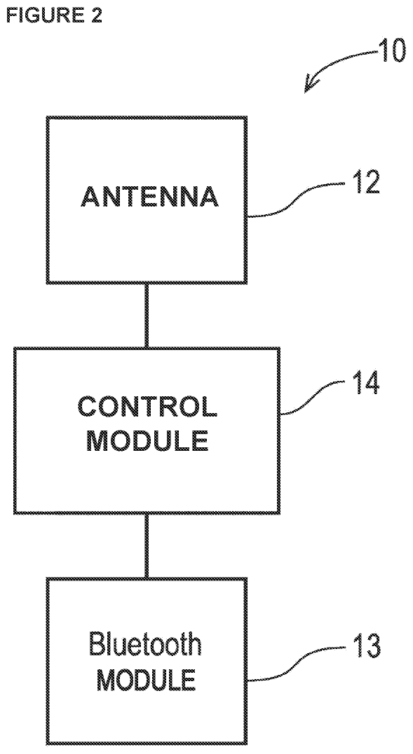

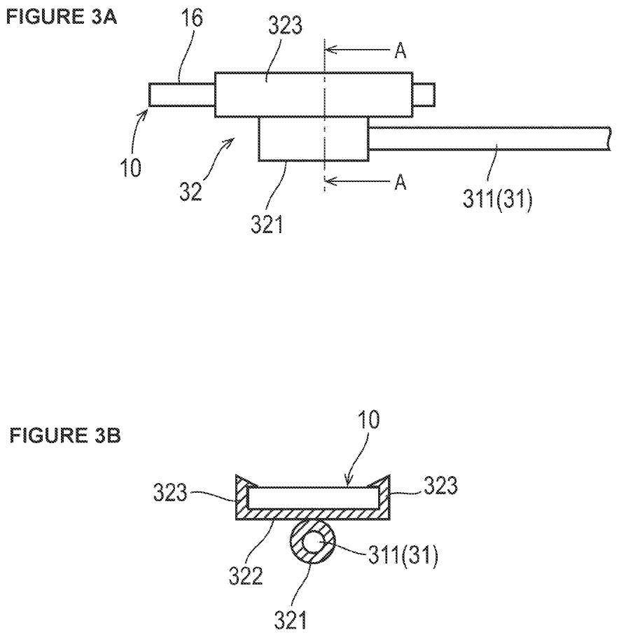

The RFID unit 10 transmits and receives information to and from an RF tag, and includes, as shown in FIG. 2, an antenna 12, a control module 14, and a Bluetooth (registered trademark) module 13 that are housed in a flat case 16 (FIGS. 1A and 1B and FIGS. 3A and 3B).

The antenna 12 outputs radio waves that are wireless signals for communicating with RF tags attached to commodities, and is typically a long-distance wireless antenna such as a UHF band antenna, which can also be a short-distance wireless antenna such as an LF band antenna or an HF band antenna. The control module 14 is connected to this antenna 12 by wire.

The control module 14 controls the antenna 12 to transmit and receive information, and includes a transmission circuit and a reception circuit connected to the antenna 12, a modulation circuit connected to the transmission circuit, a demodulation circuit connected to the reception circuit, a D/A conversion circuit connected to the modulation circuit, an A/D conversion circuit connected to the demodulation circuit, and a microcomputer connected to the D/A conversion circuit and the A/D conversion circuit. The signal output from the microcomputer is D/A converted and modulated, and then output from the antenna 12 via the transmission circuit. The signal received from the antenna 12 is demodulated through the reception circuit, A/D converted, and input to the microcomputer. The microcomputer of this RFID unit 10 is connected to the Bluetooth module 13, and wirelessly transmits information read from RF tags to the mobile information terminal 20 via the Bluetooth module 13.

These antenna 12, control module 14, and Bluetooth module 13 are operated by the power supplied from a secondary battery (not shown) placed within the case 16.

The mobile information terminal 20 shown in FIGS. 1A and 1B is an information terminal, including known smartphones and tablet terminals, and includes a touch panel display, a Bluetooth module, a Wi-Fi module, a CPU, and a memory. The memory of this embodiment has an application preinstalled therein, which manages the commodity inventory at the store based on the information acquired from the RFID unit 10 via the Bluetooth module. The CPU executes the application to manage the inventory in the store based on the information on the commodities received from the RFID unit 10.

The RFID reader 1 of this embodiment includes the extendable rod 30 that holds the RFID unit 10 and mobile information terminal 20, and the extendable rod 30 has an extendable section 31.

As shown in FIGS. 1A and 1B, the extendable section 31 has a plurality of rods (in this embodiment, the first rod 311 to the fourth rod 314) having different diameters that are fitted in the order of the diameter, and thus extends and contracts in multiple stages. In this embodiment, the diameter increases in the order of the first rod 311 to fourth rod 314 so that the third rod 313 is fitted into the fourth rod 314 to be drawable, the second rod 312 is fitted into the third rod 313 to be drawable, and the first rod 311 is fitted into the second rod 312 to be drawable.

The extendable section 31 has a unit holder 32 at the distal end (the distal end of the first rod 311). The unit holder 32 holds the RFID unit 10. For instance, as shown in FIGS. 3A and 3B, the unit holder 32 includes: an insertion portion 321 through which the first rod 311 of the extendable section 31 is inserted; a flat base portion 322 extending over the insertion portion 321; and a pair of locking portions 323 protruding upward from both ends of the base portion 322. The base portion 322 has the same width dimension as the RFID unit 10, and the RFID unit 10 placed on the base portion 322 is locked on both side faces by the pair of locking portions 323, whereby the RFID unit 10 is held.

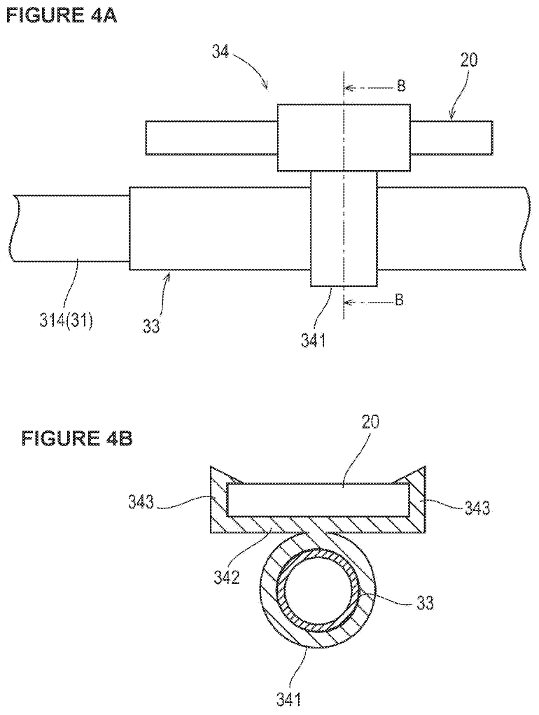

As shown in FIGS. 1A and 1B and FIGS. 4A and 4B, the RFID reader 1 has a handle 33 at the proximal end of the extendable section 31 (proximal end of the fourth rod 314). The handle 33 is held (grasped) by a user who uses the RFID reader 1 of this embodiment, and has a rod shape. The RFID reader 1 has a terminal holder 34 at the handle 33.

The terminal holder 34 holds the mobile information terminal 20, and includes: a ring portion 341 into which the handle 33 is inserted; a flat base portion 342 extending over the ring portion 341; and a pair of locking portions 343 protruding upward from both ends of the base portion 342. The base portion 342 has the same width dimension as the mobile information terminal 20, and the mobile information terminal 20 placed on the base portion 342 is locked on both side faces by the pair of locking portions 343, whereby the mobile information terminal 20 is held.

The RFID reader 1 of this embodiment has the extendable section 31 that extends and contracts, whereby the distance between the RFID unit 10 and the handle 33 is made longer and shorter. This allows the RFID unit 10 to be placed not only at the user's hand but also at a distance from the user's hand, thereby expanding the readable range without impairing the operability.

That is the descriptions on one embodiment of the present disclosure. The present disclosure is not limited to this embodiment and can include modification examples as follows.

### Modification Example 1

The above embodiment has the RFID unit 10 with the antenna 12 and control module 14 to read information from RF tags, which are machine-readable media. The present disclosure can include a sensor unit with a sensor to read information from other machine-readable media.

For instance, it can be a camera unit that includes an image sensor to capture images of one-dimensional symbols or two-dimensional symbols that are machine-readable media. In addition to the image sensor, the camera unit includes a lens located in front of the image sensor to form an image on the image sensor, and a control module that generates an image based on a signal output from the image sensor. The image generated by the control module is transmitted to the mobile information terminal 20 via the Bluetooth module that the camera unit includes. The mobile information terminal 20 analyzes the image received via the Bluetooth module and obtains information on the symbol.

### Modification Example 2

The present disclosure is not limited to the above embodiment about the manner of holding the RFID unit 10 by the unit holder 32 and the manner of holding the mobile information terminal 20 by the terminal holder 34. For instance, the extendable rod 30 can have a magnet at the distal end and the case of the RFID unit 10 can include a metal, so that the RFID unit 10 is attracted to the magnet for holding. In this modification, the magnet functions as the unit holder. Alternatively, the handle 33 can include a magnet and a thin metal plate can be placed on the back of the case of the mobile information terminal 20, whereby the mobile information terminal 20 is attracted to the magnet for holding.

### Modification Example 3

The extendable rod 30 of the RFID reader 1 of the above embodiment can include a joint at the distal end of the extendable section 31, at the middle of the extendable section 31, or at the proximal end of the extendable section 31. The joint at the distal end of the extendable section 31 connects the first rod 311 and the unit holder 32, and connects them so that the posture (orientation) of the unit holder 32 relative to the first rod 311 is changeable for holding. The joint at the middle of the extendable section 32 connects the second rod 312 and the third rod 313, and connects them so that the posture (orientation) of the second rod 312 relative to the third rod 313 is changeable for holding. The joint at the proximal end of the extendable section 32 connects the fourth rod 314 and the handle 33, and connects them so that the posture (orientation) of the fourth rod 314 relative to the handle 33 is changeable for holding. In this way, the extendable rod 30 can have a joint, whereby the direction of radio waves output from the antenna 12 is changeable.

### Modification Example 4

In Modification Example 3, the extendable rod 30 has a joint, whereby the direction of radio waves output from the antenna 12 is changeable. The extendable section 31 of the extendable rod 30 can be bendable. For instance, the first rod 311 of the extendable section 31 can include a corrugated tube, and can be configured to bend in any direction desired by the user.

1. A reader comprising:
a sensor unit having a sensor configured to read information from a machine-readable medium,
a mobile information terminal configured to acquire information from the sensor unit; and
an extendable rod configured to extend and contract, and hold the sensor unit and the mobile information terminal,
the extendable rod including
a unit holder configured to hold the sensor unit, and
a terminal holder at a handle that the extendable rod has and is configured to be grasped by a user, the terminal holder holding the mobile information terminal,
the extendable rod being extendable so as to shorten and lengthen a distance between the sensor holder and the handle.
